(19) United States
(12) Patent Application Publication
(10) Pub. No.: US 2012/0047361 A1
(43) Pub. Date: Feb. 23, 2012

(54) METHOD FOR SECURING COMMUNICATIONS IN A WIRELESS NETWORK, AND RESOURCE-RESTRICTED DEVICE THEREFOR

(75) Inventors: Bozena Erdmann, Eindhoven (NL); Philip Andrew Rudland, Sunderland (GB); Klaus Kursawe, Eindhoven (NL); Oscar Garcia Morchon, Eindhoven (NL)

(73) Assignee: KONINKLIJKE PHILIPS ELECTRONICS N.V., EINDHOVEN (NL)

(21) Appl. No.: 13/318,690

(22) PCT Filed: Apr. 26, 2010
(86) PCT No.: PCT/IB10/51814

§ 371 Date: Nov. 3, 2011

(30) Foreign Application Priority Data
May 5, 2009 (EP) 09305400.5

(51) Int. Cl. H04L 9/00; H04L 29/06; H04W 12/02

(52) U.S. Cl. 713/150

(57) ABSTRACT

The present invention relates to a method for securing communications between a resource-restricted device (1) and a receiving device (2) according to a wireless protocol, the method comprising the following steps: -storing, in a first part (11) of a non-volatile memory of the resource-restricted device (1), at least one encrypted payload, -storing, in a second part (12) of the non-volatile memory of the resource-restricted device (1), a pointer pointing towards an encrypted payload stored in the memory, -when a transmission is to be performed by the resource-restricted device (1), sending the encrypted payload indicated by the pointer, and storing, in the second part (12) of the non-volatile memory an updated pointer indicating a next-to-be-used encrypted payload stored in the memory.

### FIELD OF THE INVENTION

The present invention relates to a method for securing communications involving a batteryless device, for example in a ZigBee network.

This invention is, for example, relevant for being used in wireless control networks used for sensitive and critical applications such as medical sensor networks, or security and safety systems. This invention may also be relevant for wireless networks used for convenience applications like domestic applications or commercial building automation.

### BACKGROUND OF THE INVENTION

Wireless control networks have recently become a ubiquitous trend in the field of communication, especially for building management systems. Wireless technologies present major advantages in terms of freedom of placement, portability, and installation cost reduction, since there is no need for drawing cables and drilling. Thus, such technologies are particularly attractive for interconnecting detecting, automation, control or monitoring systems using sensor devices such as light switches, light dimmers, wireless remote controllers, movement or light detectors that have to be set up in distant places one from the other and from the devices they control, e.g. lights. Moreover, in medical sensor networks, wireless control networks allow monitoring a patient without bothering him with wires all over his body, thus allowing for the recovery-supporting patient mobility.

In wireless networks of the like, communication security is a key issue in order to avoid any disturbance of network operation due to accidentally connecting or malicious external devices. Messages exchanged between different devices in a wireless network are generally encrypted, by using keys, in order to protect the privacy of the exchange; authenticated, to validate origin and unchanged content of the exchange; and numbered or time stamped, to assure their freshness and prevent replay attacks. For example, security processes are useful to:
avoid annoyances resulting from third persons unintentionally or intentionally remotely controlling devices of a network owned by a user,
avoid unnecessary energy expenses, for example from devices maliciously turned on, and most important,
avoid external intrusions in highly sensible networks such as medical networks, safety systems like fire alarm, or security systems like burglary alarm.

Existing security systems are very energy-hungry, because they carry out highly-complex encryption algorithms for encrypting packets. As an example, with an AES (Advance Encryption Standard) algorithm, comprising several rounds, encryption of one packet on an embedded platform requires 200 μJ. Accordingly, these security systems can not be used easily in resource-limited devices such as batteryless devices, harvesting very limited amount of energy from their environment or from a user interaction such as e.g. button push. It has been proposed, for decreasing the energy-consumption in security systems, to implement the security algorithms in hardware and not in software. However, the amount of saved energy is not high enough to offer a correct solution for batteryless devices. Moreover, in existing systems, additional information is to be transmitted with a protected packet, for example an initialisation vector required for decryption, or a message authentication code required for integrity check, which increases the energy cost of transmitting the packet beyond the energy budget available on the batteryless devices. Furthermore, existing solutions require updating and storing a unique sequence number, being part of the initialisation vector, or other security-related per-packet information for each packet sent; and, in case of bidirectional communication, also for each packet received. In case of batteryless devices, this information cannot be stored in the random access memory (RAM), since it would be lost as soon as the harvested energy is exhausted; thus it must be stored in a non-volatile memory, which is an extremely energy costly operation. Furthermore, in existing systems using block ciphers, it is sometimes necessary to transmit complete block sizes in certain cipher modes, which leads to an additional packet overhead. Finally, the keys used for security services have to be sent to the device by a central node, often involving key establishment protocols of multiple steps, which feature leads to additional energy-consumption, far above the average budget of a batteryless device.

Accordingly, there is a need for a security solution for batteryless devices that overcomes at least some of the above-mentioned drawbacks.

### SUMMARY OF THE INVENTION

It is an object of the invention to propose an energy-efficient security solution for wireless communication, suitable for use with conventional energy harvesters providing low energy level.

It is another object of the invention to propose a method that can be used without modifying the security services of a given wireless communication protocol or the nodes in the network operating according to this wireless communication protocol.

It is another object of the invention to propose a method that can be used without modifying parent nodes in a ZigBee network.

To this end, the invention provides a method for securing communications between a resource-restricted batteryless device and a full-function device in a wireless network, operated according to a wireless protocol, for example a ZigBee protocol.

The method comprises the following steps:
storing, in a first part of a non-volatile memory of the batteryless device, at least one encrypted payload,
storing, in a second part of the non-volatile memory of the batteryless device, a pointer pointing towards an encrypted payload stored in the memory,
when a transmission is to be performed, sending the encrypted payload indicated by the pointer, and
storing, in the second part of the non-volatile memory an updated pointer indicating a next-to-be-used encrypted payload stored in the memory.

In one embodiment of the method, the first step may also comprise storing, in the first part of the non-volatile memory of the batteryless device, parts of a header of the message to be further transmitted, these parts comprising, for example, an init vector, or addresses.

This method allows for saving energy used for security-related services while maintaining ability of the resource-restricted communication device to use the required security services as specified by the wireless communication protocol, for providing a required security level depending on the type of network. Indeed, a batteryless device carrying out such invention does not have to encrypt the sent packets itself, since a number of encrypted packet payloads is already stored in a non-volatile memory of the batteryless device, thus it can save energy on this operation. Furthermore, it doesn't have to update long information in a non-volatile memory, because it only needs to store a short pointer, thus it can save energy on this operation as well. Moreover, such a method does not involve any modification of the batteryless device's parent, since standard security services as defined by the communication protocol (e.g. ZigBee) are used to protect and thus also to validate the information sent by the batteryless device, and the standard frame format is used by the batteryless device itself.

In an exemplary embodiment of the present invention, the method further comprises the following steps:
the batteryless device sending a message indicating that it is running out of encrypted payloads,
a control device of the network ordering a configuration process for refilling the device with new encrypted payloads, or
the control device sending to the batteryless device an authorization to reuse an already sent encrypted payload.

This feature is useful to maintain a good security level in communications when all encrypted packet payloads have already been sent once. Actually, when all the key material has been used, the most secure process would consist in refilling the device with new key material. However, in many settings, for example if a restource-restricted device has enough key material for 10 years, it can be assumed that no attacker will have the patience to wait 10 years between eavesdropping on the radio communication and being able to use the results, and thus, the security level should be sufficient for most applications even if no refilling of the device is performed and key material is re-used.

In another examplary embodiment, a method according to the invention also comprises the following steps:
a parent device of the batteryless device receiving, from this child, a packet secured with an encrypted payload, and
the parent device determining, upon receipt of this packet, that the packet is coming from a batteryless device and is protected with a recently expired key, but the sequence number is valid for that child, i.e. higher than the one recently used;
the parent device informing the control device about the need of batteryless device reconfiguration with the new key;
the parent device determining a limited period of time during which it will accept communications from this batteryless device secured with the old key.

Other embodiments of a method according to the invention will become apparent when describing a resource-restricted batteryless device according to the invention.

Such a device according to the invention comprises wireless communications means for exchanging messages with other devices in a network according to a wireless communication protocol, and a non-volatile memory, wherein the non-volatile memory:
is preconfigured with at least one encrypted payload stored in a first part of the non-volatile memory, wherein the encrypted payload is protected with the key material used for securing communications with other devices, and
stores a pointer designating the next-to-be-used encrypted payload, the pointer being stored in a second part of the non-volatile memory, and
   the device also comprising control means arranged for transmitting the encrypted payload indicated by the pointer to a remote device.

In a specific embodiment, a device according to the invention further comprises
an energy harvester, and
means for using harvested energy for generation of the encrypted payloads instead of storing the harvested energy that was not immediately used for other purposes.

Indeed, for some energy harvesting devices, e.g., devices equipped with solar cells to harvest solar power, the amount of energy that can be harvested depends on the time of the day or even the time of the year. Accordingly, instead of, or in addition to, storing the excessive energy, those devices could use the excess harvested energy to compute and write into the non-volatile memory the new encrypted payloads, and use them when they need to send a message with low energy. This enhances the possibilities of energy management, without the related costs and problems, like leak currents, associated with energy storage.

These and other aspects of the invention will be apparent from and will be elucidated with reference to the embodiments described hereinafter.

Hardware configuration of the memory, as well as composition of the encrypted packet payloads will be further detailed on the example of ZigBee wireless communication protocol.

### BRIEF DESCRIPTION OF THE DRAWINGS

The present invention will now be described in more detail, by way of example, with reference to the accompanying drawings, wherein:

FIG. 1 shows a network comprising a batteryless device according to the invention.

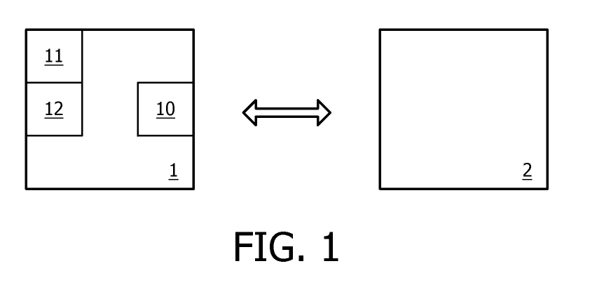

### DETAILED DESCRIPTION OF THE INVENTION

The present invention relates to a resource-restricted device 1 comprising communication means 10 for exchanging messages with another device 2. Devices 1 and 2 belong to the same wireless network. This network is, for example, a personal network, or a wireless sensor networks, or a home automation network. Actually, the invention finds an advantageous application in batteryless devices for wireless control networks, especially for sensitive and critical applications like implants and other medical sensors, security and safety systems. It can also be used in convenience applications like lighting control networks, building automation, home automation, and CE remote control. The network may operate according to, for example, ZigBee wireless communication protocol, Batteryless ZigBee protocol, ZigBee RF4CE protocol, other IEEE802.15.4-based protocol, IEEE802.15.6 protocol, EnOcean proprietary protocol, BlueTooth protocol, etc.

More precisely, a method and device according to the invention are especially suitable for resource-restricted devices, such as light switches, presence and light detectors, and other devices with very limited number of to-be-communicated states, attributes or commands, like:
toggle switch with one state,
light switch with two states, on and off,
any other two-state switch, like a garage door opener with two positions, open and close;
door or window opening sensor with two positions, on and off,
a dimming switch for level control, with X% up and X% down, (or up, down, stop commands)
light level, daylight sensor, or any other threshold-based sensor with three states: “within limit”, “above the threshold”, and “below the threshold”,
   For all those different state data, that may be transmitted by the batteryless device, a separate encrypted payload has to pre-calculated and stored in the non-volatile memory of the resource-restricted device.

Even more specifically, a device and method according to the invention are especially suiable for energy-harvesting batteryless devices, with very limited enery budget, such as pushbutton energy-harvesting light switch, solar energy-harvesting presence or light detector.

The resource-restricted device 1 comprises a non-volatile memory separated in two parts 11 and 12. The first part 11 is used for storing encrypted packet payloads, and the second part 12 is used for storing a pointer indicating the next payload to be used for secure communication. Since one of the objects of the invention is to provide a method that allows saving energy, the memory access operations have to be energy-efficient themselves. Thus, both parts of the non-volatile memory have to be optimized depending on their usage. Thus, in a preferred embodiment, the first part and the second part of the memory are realized with different technologies, so as to allow an independent optimization. Thus, the bulk part 11 of the memory, i.e. the part storing the encrypted packet payloads, is beneficially optimised for the frequent reading operations, because the writing is a special configuration operation, that is performed rarely, potentially with use of special tools or external energy supply. On the other hand, the part 12 of the memory, storing the pointer, has to be optimised both for reading and writing, because the device has to first read the previous pointer and then to store, i.e. to write to the memory, a new pointer after sending each packet. Moreover, this memory 12 has to allow for storage of small block lengths, because the pointers are generally 1 to 4 bytes-long, depending on the security service design. Please note that the pointer itself may be shorter than the sequence number, as it only needs to cover the number of payloads stored at the device. In addition to the hardware means, such as a special memory 12 type, software means can be used as well to minimize energy consumption for pointer storage. If the pointer is used as part of the initialization vector or sequence number, a fixed prefix may be stored at another location in the non-volatile/program memory. Furthermore, the pointer stored in part 12 of the non-volatile memory could be structured or coded according to Gray coding, which requires writing of single bit only for each consecutive pointer incrementation, independent of the actual pointer length, which allows for considerable energy savings.

In another embodiment, the two memory parts can be realised with the same efficient technology, for example a CMOS-based non-volatile RAM (nvRAM).

As explained before, a method according to the invention allows reducing the energy-cost of a security processing by storing already-encrypted packets in a memory of a batteryless device, thus eliminating the energy-expenses for encryption. However, in such a method, energy is still needed for transmitting the encrypted packet payloads. Thus, in some embodiments of the present invention, it is proposed to decrease the size of the payloads in order to save more energy. Moreover, a decrease of the payload size also allows saving memory.

Such a reduction of the payload size is explained below on the example of ZigBee communication protocol. In ZigBee, resource-restricted device 1, called ZigBee End Device, communicates solely via its parent 2, called ZigBee Router, who handles and, if necessary forwards, any packet received from device 1. Indeed, as soon as the device 2 is aware of the limited capabilities of its child 1, it could cope with a different frame format send by the resource-restricted child. The awareness of the parent device is made possible by using the capability information, either exchanged during the joining process, as results of manual configuration, or thanks to a special bit in Frame Control field of either MAC, NWK or application layer.

Thus, in an advantageous embodiment of a method according to the invention, the ZigBee End Device 1 drops the following ZigBee auxiliary network security header fields, included in conventional ZigBee frames:
8B Source address—which must be known to the parent from the commissioning or joining procedure,
1B Security control—larger parts of which (Security Level and Key Identifier subfields), are anyway common for the entire ZigBee network.
   As a result, the length of payloads of ZigBee on/off light switch is reduced to 24 Bytes instead of 33 Bytes, wherein a payload comprises:
an auxiliary security network header encoded on 5 bytes only, consisting of Frame Counter value, encoded on 4 bytes and a Key sequence number encoded on 1 byte,
an encrypted network frame payload encoded on 19 bytes.

As a consequence, the required memory for storing the payload required for one year operation, on average twice a day, of ZigBee on/off light switch can be reduced to 35040 Bytes, instead of 48180 Bytes with conventional ZigBee frames. The pointer value for the 730 encrypted payloads can be stored on 10 bits of memory 12.

In another advantageous embodiment of a method according to the invention, the ZigBee End Device 1 stores only a unique part of the Frame Counter value per encrypted payload, whereas the common part is just stored once and appended when the packet is constructed for sending. This allows for further reducing the amount of memory required. In the example above, only 730 encrypted payloads need to be stored for one year of operation at an average frequency of 2 times a day. All numbers up to 730 can be binary encoded on just 10 bits, instead of 32 bits, thus in total saving additional over 2000 Bytes.

In another advantageous embodiment of a method according to the invention, the device 1 is a ZigBee Batteryless Device, and the device 2 is ZigBee Batteryless proxy device, communicating using the wireless protocol specification as defined by the Batteryless ZigBee feature.

In yet another advantageous embodiment of a method according to the invention, the device 1 is a ZigBee Batteryless Device, and the device 2 is ZigBee Batteryless proxy device, communicating using the wireless protocol specification as defined by the ZigBee RF4CE feature.

In wireless networks, several cipher modes can be used for performing block cipher encryption. For most of these modes, full blocks of a block cipher have to be transmitted, which may cause large security-related overhead, depending on the relation of payload size to block size. It has to be noted that neither the to-be-encrypted payload, nor the cipher block size can be optimised. Accordingly, for reducing the block cipher overhead in such a mode, a method is proposed here in which parts of the auxiliary security header are shifted into the encrypted payload.

An auxiliary security header comprises an initialisation vector used by block ciphers for ensuring replay protection and providing randomisation for the process. Such a vector does not need to be secret, but should not be repeated with the same key. Both functions are still fulfilled in this method where the vector is shifted into first fields of the to-be-encrypted payload instead of in the block cipher. Indeed, replay attacks can still be detected after decryption, and the vector field being the initial part of the payload prevents common prefix and guarantees the randomness of the encrypted outcome, independent of the actual message content.

Since a resource-restricted device 1 according to the invention has limited memory resources, it can store only a certain number of encrypted packet payloads, and thus it might sometimes run out of encrypted payloads. In such a case, it is useful to refill the device with new encrypted packet payloads for further operation. This refill operation can also be triggered upon request of the parent device 2, or of another device in the network. Alternatively, the parent can decide, or can be instructed by an infrastructure device, such as ZigBee Trust Centre device in the ZigBee network, to allow the resource-restricted device to re-use the already used encrypted payloads.

Furthermore, the configuration of the resource-restricted device with the key material may be required due to the key update in the wireless communication network. The resource-restricted device, especially an energy-harvesting one, may not be able to receive the key update. Thus, after key reconfiguration and upon receiving a packet from a batteryless child 1 secured with the old key but with appropriate sequence number for the child 1, the parent device 2 could decide to accept the communication from the child 1 for some time. It could inform the user about the need of manual re-configuration of the batteryless device, e.g. by sending a message to the ZigBee Trust Centre.

A method according to the present invention can further be advantageously used in a star-shaped network, i.e. a network where many resource-restricted devices send messages to a more powerful device, because it allows for using the same key in all devices without increasing the risk of compromising the key material. Indeed, since the resource-restricted devices, which also appear to be the less-secured ones, only store already encrypted messages, hacking devices of the like would not reveal any information about the key used for encryption. Thus, using one master key shared by all resource-restricted devices does not pose an additional security risk. It allows for minimizing the key-related storage on the central device.

The present invention is more especially dedicated to wireless networks such as medical sensor networks, personal home networks, light networks, or any other network of the like.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of wireless communication and security and which may be used instead of or in addition to features already described herein.

1. Method for securing communications between a resource-restricted device (1) and a receiving device (2) according to a wireless protocol, the method comprising the following steps:
storing, in a first part (11) of a non-volatile memory of the resource-restricted device (1), at least one encrypted payload,
storing, in a second part (12) of the non-volatile memory of the resource-restricted device (1), a pointer pointing towards an encrypted payload stored in the memory,
when a transmission is to be performed by the resource-restricted device (1), sending the encrypted payload indicated by the pointer, and
storing, in the second part (12) of the non-volatile memory an updated pointer indicating a next-to-be-used encrypted payload stored in the memory.

2. Method as recited in claim 1, further comprising, when all encrypted payloads stored in the memory of the batteryless device have been sent once, the following steps:
the resource-restricted device sending a message indicating that it is running out of encrypted payload,
a control device of the network ordering a configuration process for refilling the device with new encrypted payloads, or
the control device sending to the resource-restricted device an authorization to reuse an already sent encrypted payload.

3. Method as recited in claim 1, further comprising the steps:
a receiving device receiving, from the resource-restricted device, a packet secured with an encrypted payload, and
the receiving device determining, upon receipt of this packet, that the packet is coming from a resource-restricted device encrypted with a recently expired or replaced key, and with a sequence number valid for this resource-restricted device;
the receiving device informing the end-user about the need of resource-restricted device reconfiguration;
the receiving device determining a limited period of time during which it will accept communications from this resource-restricted device secured with the old key.

4. A resource-restricted device comprising wireless communications means for exchanging messages with other devices in a network according to a wireless communication protocol, and a non-volatile memory, wherein the non-volatile memory is preconfigured with:
at least one encrypted payload stored in a first part of the non volatile memory, wherein the encrypted payload corresponds to a key material used for securing communications with other devices, and
a pointer designating the next-to-be-used encrypted payload, the pointer being stored in a second part of the non-volatile memory, and
the device further comprising control means arranged for transmitting the encrypted payload designated by the pointer to a remote device with which communication has to be established.

5. A resource-restricted device as recited in claim 4, wherein the first part and the second part of the memory are realized with different technologies.

6. A resource-restricted device as recited in claim 5, wherein the first part of the memory is optimized, in terms of energy efficiency, for reading operations.

7. A resource-restricted device as recited in claim 5, wherein the second part of the memory is optimized for both reading and writing operations.

8. A resource-restricted device as recited in claim 7, wherein the pointer is implemented according to Gray coding.

9. A resource-restricted device as recited in claim 8, wherein the resource restricted device is power-restricted device.

10. A resource-restricted device as recited in claim 9, wherein the power-restricted device is an energy-harvesting batteryless device.

11. A device as recited in claim 10, further comprising:
an energy harvester, and
means for using remaining harvested energy for generation of the encrypted payloads instead of storing the energy.

12. A device as recited in claim 11, wherein the wireless communication protocol is a ZigBee protocol, or a Batteryless Zigbee protocol, or a ZigBee RF4CE protocol.

13. A device as recited in claim 12, wherein the length of payloads stored in the memory is 24 Bytes, and wherein a payload comprises :
an auxiliary security network header encoded on 5 bytes,
an encrypted network frame payload encoded on 19 bytes.

14. A device as recited in claim 13, wherein the auxiliary security network header comprises a Frame counter value, encoded on 4 bytes and a Key sequence number encoded on 1 byte.

15. A device as recited in claim 14, further comprising:
an energy harvester, and
means for using harvested energy for transmission of the encrypted payloads instead of storing it.
